(19) United States
(12) Patent Application Publication
(10) Pub. No.: US 2008/0107846 A1
(43) Pub. Date: May 8, 2008

(54) Composite Hollow Body And Method And Device For Making Same

(75) Inventors: Christophe Ducret, Chambery (FR); Jacques Voiron, St-Jean De Couz (FR); Caroline Seraine, Chambery (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN VETROTEX FRANCE S.A, CHAMBERY (FR)

(21) Appl. No.: 11/578,433

(22) PCT Filed: Apr. 26, 2005
(86) PCT No.: PCT/FR05/50279

§ 371 Date: Oct. 17, 2006

(30) Foreign Application Priority Data
Apr. 29, 2004 (FR) 0404574

(51) Int. Cl. B29C 53/66; B29C 53/70; F16L 9/127; B29C 53/84; B29D 23/00; B29C 41/08; B29C 41/00; B29C 41/46; B05D 1/12; B05D 1/04

(52) U.S. Cl. 428/34.7; 264/634; 118/304; 428/34.6

(57) ABSTRACT

A method of manufacturing a composite hollow body including an internal coating and at least one external coating of composite based on thermoplastic and glass. A powder is sprayed onto a support of a shape suited to the shape of the hollow body to cover the support, and a composite heated tape configured to form the external coating of the body is wound around the support covered with powder, the heat of the tape helping to melt the powder.

The present invention relates to the manufacture of a body formed of at least one organic thermoplastic reinforced with continuous glass strands wound around the body. Although not limited to such an application, the invention will be described more specifically with reference to the manufacture of pipes, particularly those intended to transport fluids under pressure. The invention is aimed more specifically at the pipes used in civil engineering, for transporting liquids or gases, such pipes, generally rigid and able to withstand pressures that may be both internal and/or external, possibly reaching very large sizes and a high weight. In particular, the pipes at which the present invention is aimed may have diameters ranging from the order of one or a few centimetres to two or three metres and a length ranging from a few centimetres to several tens of metres, these pipes, generally of significant weight, having, as the case may be, to exhibit resistance to deformation under pressures ranging from atmospheric pressure to several tens of bar, remain impervious over time, etc.

Another beneficial application is the manufacture of tanks (which may be formed in one piece, or from pipe(s) and added-on end(s), etc.) intended to contain fluids, particularly fluids under pressure.

The manufacture of a body based on at least one organic thermoplastic reinforced with continuous glass strands wound around the axis of the body is already described in patent application WO 00/24566. In that application, a heated tape based on an organic thermoplastic and on continuous glass strands is wound around a rotating plastic tube while at the same time heating part of the surface of the tube coated with the tape and applying pressure downstream of this heated part. The tape is, for example, obtained from comingled continuous strands made up of filaments of glass and filaments of organic thermoplastic intimately mixed, marketed in particular under the trade name Twintex® by Saint-Gobain Vetrotex France.

The tube is generally extruded and made of an organic thermoplastic which may, for example, be a polyolefin of the polyethylene PE or polypropylene PP type or alternatively polyvinyl chloride (PVC). These materials have, in particular, the advantages of being chemically inert, particularly with respect to corrosion, and compatible with foodstuffs, and of being able to withstand very low temperatures.

However, the cost price of the tube in itself which is obtained by extrusion plays a not insignificant part in the final cost of manufacture of such a composite body. Now, it is always desirable to manufacture products of equal quality while at the same time managing to reduce the costs of manufacture.

It is precisely an object of the invention to provide another, less expensive method of manufacturing a composite body comprising an internal coating covered with composite material based on thermoplastic and glass, this internal coating performing the same function as an extruded tube, this method in particular being suitable for the manufacture of the pipes or tanks as mentioned hereinabove, to the specific constraints and requirements.

According to the invention, the method of manufacturing a composite hollow body consisting of an internal coating and of at least one external coating of composite material based on thermoplastic and glass, is characterized in that:
a powder is sprayed onto a support of a shape suited to the shape of the hollow body so as cover the said support, this powder being intended to constitute the material of the internal coating;
a composite heated tape intended to form the external coating of the body is wound around the support covered with powder, the heat of the tape causing the powder to melt and bonding the tape to the powder to form the composite body;
the composite body is extracted from the support after cooling.

This simplified method thus makes it possible to obtain a product produced as a single piece which comprises both the internal coating and the reinforcing layer. The product is also lighter in weight than a product of the prior art because the internal coating formed (the thickness of sprayed powder being generally less than 1 mm) is not as thick that formed hitherto of an extruded tube (the wall thickness of the extruded pipe generally ranging from 1 to 10 mm).

According to one feature, the tape is deposited on the powder, possibly in combination with the presence of a source of heat, at a temperature above or below the melting point of the powder.

Advantageously, the support may be heated internally and/or externally after the powder is deposited on its entire surface and the tape is deposited. As a preference, pressure is applied to the tape once it has been deposited.

According to another feature, the powder is sprayed by spray means which can move with respect to the support whereas the support is stationary, or vice versa.

As for the tape, it is deposited by a delivery and depositing system which performs translational and rotational movements with respect to the support whereas the said support is able to revolve during winding.

The powder is a thermoplastic such as a polyolefin or a polyamide. It may advantageously be electrostatically charged.

According to another feature, the tape contains comingled glass and thermoplastic strands, this also allowing a not insignificant weight saving for the pipes at which the invention is more particularly aimed.

The invention also relates to a device for implementing the method described hereinabove.

This device comprises a support (allowing the composite body obtained to be extracted, after cooling, this support being termed, by extension, a removable support), means for spraying a powder onto the support, a system for delivering and depositing a composite tape around the support covered in powder.

According to one feature, the spray means and the support are able to be moved one with respect to the other, whereas the system for delivering and depositing the tape is able to make translational and rotational movements with respect to the support, the said support being able to the perform rotational movements.

Advantageously, the support may be made of an electrically conducting material to ensure that the powder will stick, particularly when this powder is electrostatically charged.

The support may comprise an outer cladding membrane made of plastic. Furthermore, the support may be heating.

The device may provide an external heat source which is positioned facing the support covered in powder.

According to another feature, the device may comprise complementary heating means which are added facing the support after the tape has been deposited, and pressing means which are pressed against the tape once it has been deposited.

Thus, the invention proposes a composite hollow body consisting of an internal coating and of at least one external coating made of composite material based on thermoplastic and glass, the internal coating being obtained by melting a powder as this powder is covered with the external coating and cooling.

The internal coating is a thermoplastic, such as a polyolefin or a polyamide, for example, and the external coating is a tape, preferably of comingled thermoplastic and glass strands.

As a preference, the external coating is coated with a finishing and protective layer.

Other advantages and features of the invention will now be described in greater detail with reference to the attached drawings which depict nonlimiting embodiments and in which:

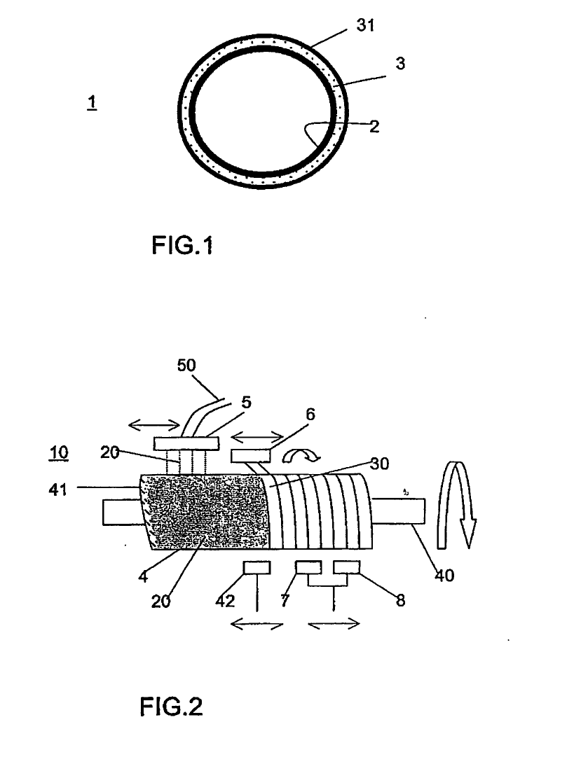

FIG. 1 illustrates a schematic section view of a composite hollow body obtained according to the method of the invention;

FIG. 2 illustrates a general schematic depiction of a device for manufacturing the composite hollow body according to the invention.

FIG. 1 shows a schematic sectioned view of a composite hollow body, here of cylindrical shape to be used as a pipe, consisting of an internal coating 2 made of a single material and at least one external coating 3 made of composite.

The internal coating 2 is a material advantageously compatible with being in contact with the fluid flowing or stored in or through the hollow body. It is advantageously made of thermoplastic such as a polyolefin of the polyethylene PE or polypropylene PP type, possibly modified (for example by the grafting of reactive polar groups), or alternatively a polyamide. This material may be electrostatically charged, the advantage of this being emphasized later on in the description.

This coating, at the start of the method of manufacture, comes in the form of a powder of variable particle size and/or variable composition. The powder is then consolidated as soon as it melts which is performed when the coating 3 is applied to it, and after cooling.

The external coating 3 is formed using a composite tape which consists of reinforcing strands, preferably glass and thermoplastic strands. These strands are advantageously intimately mixed making it possible to form a very homogeneous consolidated strip or tape, that is to say one having cohesion and integrity that allow this tape to be handled without damage. It may, for example, involve comingled strands marketed by the trade name Twintex® by Saint-Gobain Vetrotex. Such a tape is, for example, manufactured from reels of strands of the Twintex® type according to the method explained in Patent Application WO 00/24566 or EP 1 093 900.

In order to obtain a finished hollow body of the pipe type that can be used to transport fluids, it is necessary for the external wall of this pipe to be guaranteed against any external attack, and for this purpose provision is made for the composite external coating 3 of the hollow body to be coated with an external finishing and protective layer 31. This protective layer, preferably made of polyolefin, may for example be extruded or obtained by powdering (possibly preceded by heating of the body) and heating (particularly of the coating, or baking). In a more simple embodiment, this layer may also be produced in the form of an aqueous or solvent-based paint suited to the usage constraints.

The device 10 for implementing the method of manufacture of the hollow body 1 comprises a support 4 acting as a die for producing the internal coating 2 of the hollow body, means 5 for spraying a powder 20 which constitutes the internal coating 2, a system 6 for delivering and depositing the tape 30 that constitutes the external coating 3.

The support 4 is of a shape suited to the shape that the hollow body is to have. It is, for example, a mandrel in the case of a cylindrical body, of a diameter tailored to the desired cross section of the hollow body and, in particular, an expanding mandrel.

The support is preferably made of metal with minimal roughness. When this support is made up of several sections, it may be covered with a plastic membrane 41, such as a silicon membrane, so as to prevent the join between two sections being reproduced in the form of a marking on the internal part of the internal coating 2 of the body after manufacture.

The spray means 5 are, for example in the form of a gun connected to a flexible hose 50 supplying the powder 20.

The support 4 is able to rotate about a shaft 40 and the spray means are able to move in terms of translation, so as to deposit the powder 20 on the entire surface of the support that is to be covered in order to constitute the final shape of the hollow body.

The support 4 may or may not be a heating support depending on the type of powder deposited.

The powder 20 is a thermoplastic as described above for the internal coating 2 obtained by consolidating the powder 20 after heating and cooling. By way of examples of powders, mention may be made of the products Plascoat PPA 571 Easyflow by Plascoat, Abcite X70 by Dupont Powder Coating, and Rilsan by Atofina.

When this powder is electrostatic, it has the advantage of remaining more readily attached to the metal support.

The material of the powder may or may not be compatible with the thermoplastic of the tape, and mention will then be made of adhesion, between the powder and the tape, which is either chemical or, respectively, mechanical.

The system 6 for delivering and depositing the tape 30 is a head that can move in terms of translation and in terms of rotation with respect to the surface of the support coated with powder, the angle of inclination given to the head being tailored to the desired circumferential or helical angle of wrapping of the tape.

The delivery and depositing head 6 comprises rotating heated rollers at a heating and regulating temperature which allow the tape as it exits to be kept at a temperature 20to 50° C. higher than the melting point of the thermoplastic of which the tape is made. A head such as this is described for example in Patent Application WO 00/24566.

The tape is wound around the support coated with powder by suitably inclining the head and by moving it in a number of outward and return travels parallel to the longitudinal axis of the tube, and by pivoting it.

The adhesion of the powder to the tape and its conversion into a consolidated coating are brought about by the melting of the powder and its cooling. In order to reach the melting point of the material of which the powder is made, the tape deposited on the powder has either a melting point of its thermoplastic higher than that of the powder or, if it is lower, a heating source needs then to be provided in order to melt the powder.

Although the temperature of the tape in the delivered state may be above the melting point of the powder, it may be that the difference between the two temperatures is too insignificant to ensure correct melting. In that case, just as when the melting point of the powder is higher than that of the material of the tape, a heating source 42 is then provided, this being placed facing the support, a distance of a few centimetres away. This allows the support to be heated as soon as the tape is applied to the powder.

As an alternative, it is possible to provide this heat source near the support once the winding of the tape is completed, the heat being able to pass through the thickness of thermoplastic covering the powder so as to melt the latter.

This is, for example, hot air, or infrared radiant heating which is therefore moved along before or after the tape is applied.

As an alternative or to supplement this heat source, it is possible to envisage heating the support internally, for example by passing oil through the mandrel.

Finally, the device 10 preferably comprises complementary heating means 7 and pressing means 8.

The complementary heating means 7 may consist of the heat source 42. They are implemented straight away after the tape has been deposited or once the winding is complete.

The pressing means 8 consist of a press roller which is pressed, after one revolution or several revolutions of the winding of the tape, at the circumference of the support coated with powder, or alternatively, once the winding is fully complete. These means confirm the consolidation of the tape and of the molten powder and reduce the level of voids between the various superposed layers of tape.

The heat source 42 and/or the complementary heating means 7 such as the press roller 8 are able to move parallel to the support 4, for example by way of a mobile carriage bearing them.

All of the movements performed by the various moving parts of the device (support, spray means, system for delivering and depositing the tape, complementary heat source, pressing means) are brought about by one or more motors, and pneumatic means driven by numerical-control means.

The method of manufacture will now be described.

The mandrel 4 is set in rotation whilst the gun 5 set in operation sprays powder 20 and is moved in terms of translation along the length of the mandrel.

Once spraying is over, that is to say once the powder fully covers the mandrel, at least the surface of the shape that is to be obtained, the depositing and delivery head 6 begins to lay the tape 30. The head moves in terms of translation along the length of the mandrel while the latter is still rotating.

At the time of the depositing of the tape, the powder 20 melts to form the internal coating 2 and bonds to the tape. Depending on the type of powder, it is possible, if necessary, to heat the support internally and/or the external surface of the tape is heated just downstream of where it is being deposited in contact with the powder using the complementary heat source 42 which is moved in terms of translation along the length of the mandrel while the latter is revolving.

The complementary heating means 7 and the pressing means 8 are implemented straight away after the tape has been laid, or alternatively once the winding is complete, so as locally to heat the exterior peripheral surface of the body 1 and apply to this exterior surface a pressure to fully bond the tape 30 to the internal coating 2.

Once the body formed has cooled, it is extracted from the support.

The above method is carried out on a single manufacturing workstation. It is, of course, possible for an industrialization variant to provide at least two workstations at which the support is coated with powder and the tape is wound, respectively.

1-21. (canceled)

22. A method of manufacturing a composite hollow body including an internal coating and at least one external coating of composite material based on thermoplastic and glass, the method comprising:
spraying a powder onto a support of a shape suited to a shape of the hollow body so as cover the support, the powder configured to constitute a material of the internal coating;
winding a composite heated tape configured to form the external coating of the body around the support covered with powder, heat of the tape causing the powder to melt, and bonding the tape to the powder to form the composite body; and
extracting the composite body from the support after cooling.

23. A method according to claim 22, wherein the tape is deposited on the powder, in combination with presence of a source of heat, at a temperature above or below the melting point of the powder.

24. A method according to claim 22, wherein the support is heated internally and/or externally before and/or after the powder is deposited on its entire surface and the tape is deposited.

25. A method according to claim 22, wherein pressure is applied to the tape once the tape has been deposited.

26. A method according to claim 22, wherein the powder is sprayed by a sprayer that can move with respect to the support whereas the support is stationary, or vice versa.

27. A method according to claim 22, wherein the tape is deposited by a delivery and depositing system that performs translational and rotational movements with respect to the support, whereas the support can revolve during winding.

28. A method according to claim 22, wherein the powder is a thermoplastic, a polyolefin, or a polyamide.

29. A method according to claim 22, wherein the powder is electrostatically charged.

30. A method according to claim 22, wherein the tape contains comingled glass and thermoplastic strands.

31. A device for manufacturing a composite hollow body including an internal coating and at least one external coating of composite material based on thermoplastic and glass, the device comprising:
a support allowing the composite body obtained to be extracted;
means for spraying a powder onto the support; and
a system for delivering and depositing a composite tape around the support covered in powder.

32. A device according to claim 31, wherein the means for spraying and the support are configured to be moved with respect to the other.

33. A device according to claim 31, wherein the system for delivering and depositing the tape is configured to make translational and rotational movements with respect to the support, the support being configured to the perform rotational movements.

34. A device according to claim 31, wherein the support is made of an electrically conducting material to ensure that the powder, which is based on an electrostatic material, will stick.

35. A device according to claim 31, wherein the support comprises an outer cladding membrane made of plastic.

36. A device according to claim 31, wherein the support is heating.

37. A device according to claim 31, further comprising an external heat source positioned facing the support covered in powder.

38. A device according to claim 31, further comprising complementary heating means added facing the support after the tape has been deposited, and pressing means pressed against the tape once the tape has been deposited.

39. A composite hollow body including an internal coating and at least one external coating made of composite material based on thermoplastic and glass, the internal coating being obtained by melting a powder as the powder is covered with the external coating and cooling.

40. A hollow body according to claim 39, wherein the internal coating is a thermoplastic, a polyolefin, or a polyamide.

41. A hollow body according to claim 39, wherein the external coating is formed by a tape of comingled thermoplastic and glass strands.

42. A hollow body according to claim 39, wherein the external coating is coated with a finishing and protective layer.
